(19) United States
(12) Patent Application Publication
(10) Pub. No.: US 2018/0260921 A1
(43) Pub. Date: Sep. 13, 2018

(54) REMOTE MACHINE OPERATION THROUGH DISTRIBUTED PERMISSIONING

(71) Applicant: Bsquare Corp., Bellevue, WA (US)

(72) Inventor: David Wagstaff, Lake Forrest, CA (US)

(21) Appl. No.: 15/897,809

(22) Filed: Feb. 15, 2018

Related U.S. Application Data
(60) Provisional application No. 62/468,547, filed on Mar. 8, 2017.

(51) Int. Cl. G06Q 50/18; H04L 9/32

(52) U.S. Cl. CPC G06Q 50/18; H04L 9/32

(57) ABSTRACT

A distributed journal comprises a smart contract defining access and write permissions by stakeholders that access the distributed journal. The smart contract also defines triggering rules which must be satisfied to trigger an event. The stakeholders write to copies of the distributed journal which updates an authentication server to verify each grant and operate a remote machine.

### CROSS REFERENCE TO RELATED APPLICATIONS

This application claims the benefit of U.S. provisional patent application Ser. No. 62/468,547, filed on Mar. 8, 2017, the contents of which are incorporated by reference herein in their entirety.

### BACKGROUND

Current methods of contracting and obtaining permissions for certain activities are slow, laborious and difficult to track, leading to a high potential for mistakes. Often, systems used to obtain necessary permissions to perform a given action are implemented using email, physical checks, or sometimes centralized server. Centralized database storage often lacks redundancy, as well as controls for specifying an order in which actions must be taken.

For example, discharging water from a dam may require multiple checks before it is performed: the governor may need to sign off on it, there need to be environmental review and consent by the appropriate authority, and the finally, the dam supervisor may need to give the okay. Currently, this process is inelegant and may take a prohibitively long time, with either all parties attempting to access the same centralized system, or they must pass around a means of approval via electronic mail or similar. These methods also do not do a good job of restricting possible inputs, memorializing decisions, or maintaining redundant records for future review.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an embodiment of an environment 100.

FIG. 2 illustrates an embodiment of a distributed journal 200.

FIG. 3 illustrates an embodiment of a distributed permissioning and operation process 300.

FIG. 4 illustrates an embodiment of a distributed journal system 400.

FIG. 5 illustrates an embodiment of a system for distributed permissioning and remote machine operation 500.

FIG. 6 illustrates a system 600 in accordance with one embodiment.

### DETAILED DESCRIPTION

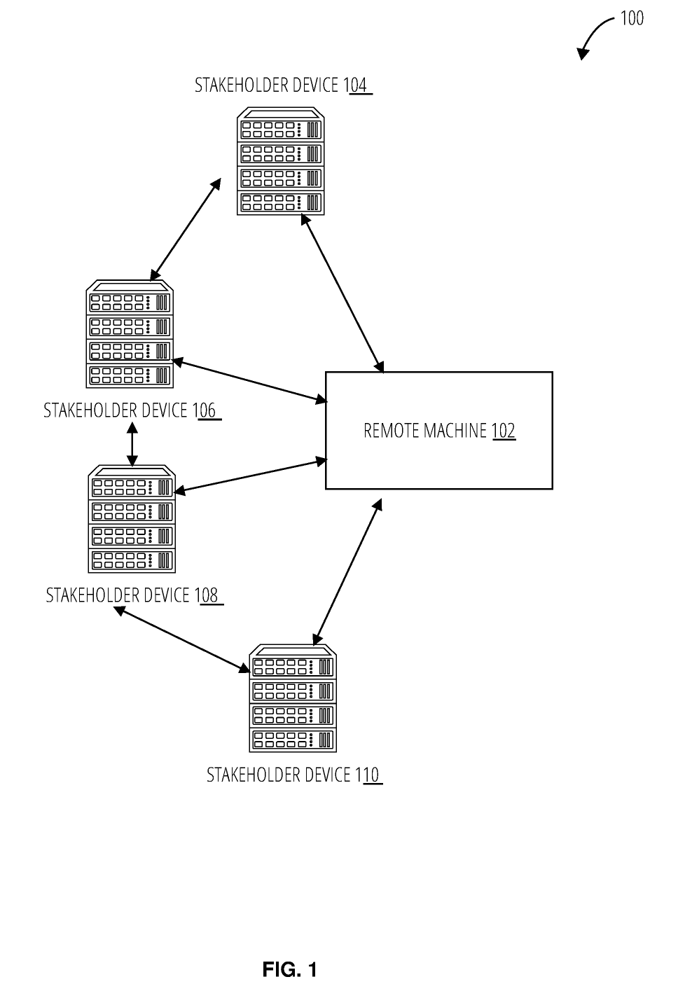

FIG. 1 illustrates an embodiment of an environment 100.

The environment 100 comprises a remote machine 102, a stakeholder device 104, a stakeholder device 106, a stakeholder device 108, and a stakeholder device 110. This is of course only an example system and other numbers of stakeholder devices may be present.

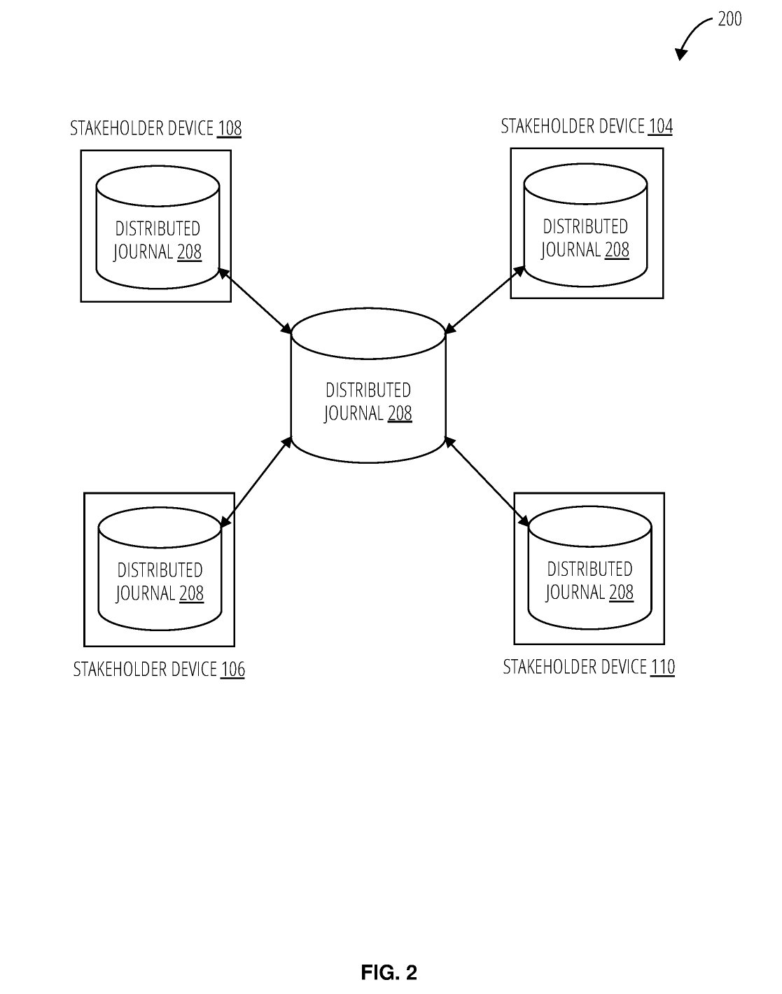

FIG. 2 illustrates an embodiment of a distributed journal 200.

The distributed journal 200 comprises a stakeholder device 104, a stakeholder device 106, a stakeholder device 108, a stakeholder device 110, a distributed journal 204, and a distributed journal 208.

Blockchain utilizes a distributed journal 208, where the database is distributed over multiple nodes, with each node comprising a copy of the database, editing its copy and updating the distributed journal, instead of having one central “point of truth” for data.

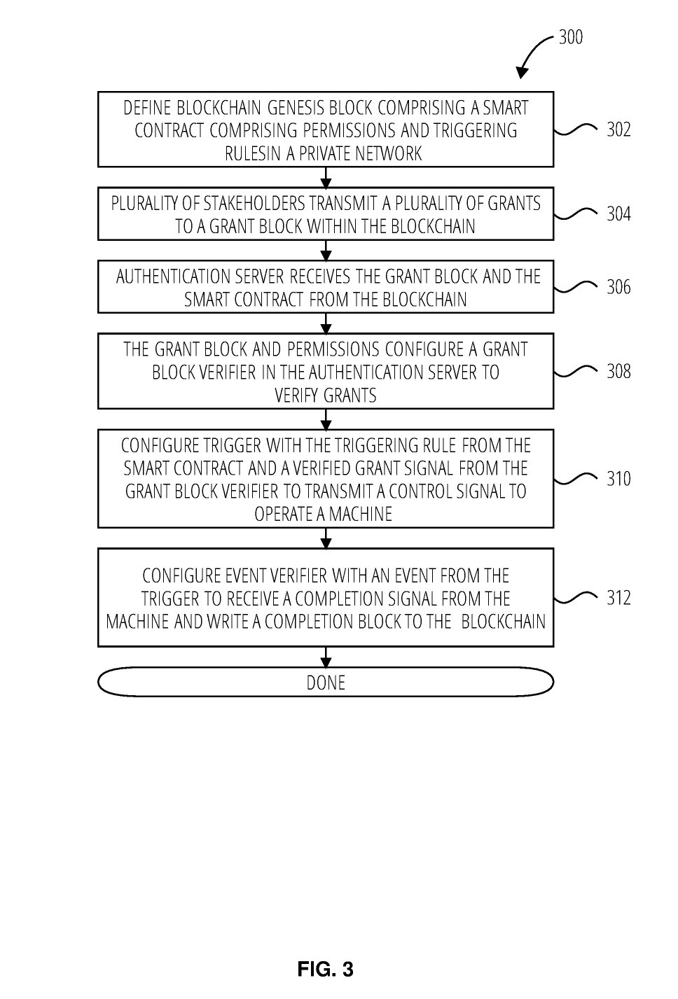

Referring to FIG. 3, the process 300 comprises defining a blockchain genesis block in a private network comprising a smart contract comprising permissions and triggering rules (block 302). A plurality of stakeholders transmit a plurality of grants to a grant block within the blockchain (block 304). An authentication server receives the grant block and the smart contract from the blockchain (block 306). The grant block and permissions configure a grant block verifier in the authentication server to verify grants (block 308). A trigger is configured with the triggering rule from the smart contract and a verified grant signal from the grant block verifier to transmit a control signal to operate a machine (block 310). The trigger may be a fully predefined programmatic condition-based rule or a consequence of an action by one or more actors, either through a human-centric process or automatically determined when specified threshold sensor values or time thresholds are met. An event verifier is configured with an event from the trigger to receive a completion signal from the machine and write a completion block to the blockchain (block 312). Event verification can be done manually through specific ‘checks’ by involved persons (visual inspection for example), or through programmatic matching, for example, a specific sensor reading or similar.

The method may include defining a genesis block of a blockchain within a private network, a group of stakeholders transmitting a group of grants to a grant block within the blockchain, an authentication server receiving the grant block and the smart contract from the blockchain, configuring a grant block verifier in the authentication server with the grant block and the permissions to verify each of the group of grants. The method may further comprise configuring a trigger with the triggering rule from the smart contract and a verified grant signal from the grant block verifier to transmit a control signal to operate a machine, and/or configuring an event verifier with an event from the trigger to receive a completion signal from the machine and write a completion block to the blockchain.

Defining a genesis block of a blockchain within a private network may include a smart contract. The smart contract may further include permissions and triggering rules. The permissions may define who may access the blockchain and who may write to each block. The triggering rules may define the necessary grants which much be recorded and written to the grant block in order to initiate an event. The stakeholders transmitting grants to the grant block may further include saving the grant to the local copy of the grant block while connected to the private network.

By way of example, a dam discharge may require certain procedures to be followed prior to the discharge occurring. It may need a governor's approval which may require that an environmental authority sign off on it as well as a damn supervisor. These may all be outlined in the smart contract, which also notes who may access the blockchain itself. Each stakeholder may have a copy of the blockchain on their computer and may edit their “grant” to give approval. The blockchain updates across all of the users' computers and the authentication server. The authentication server may compare the permissions with the grants saved to the grant block to authenticate them, and when all of the appropriate grants are received, as delineated in the triggering rules, a trigger can initiate a signal to commence the discharge, upon completion, the authentication server may save a completion block to the end of the blockchain denoting that the blockchain has been completed and that the contract has been fulfilled. This blockchain may now be used as a record to determine proper protocol was followed. Although the example given illustrates a workflow involving individual personal approvals, this concept is not limited only to human-gained approval process. The blockchain may also contain algorithm approval chains, whereupon the block is granted when certain, largely predefined, programmatic conditions are met, either distributed across multiple blocks or contained within a singular access chain.

Through the use of a peer-to-peer network and a distributed time-stamping server, a blockchain database allows for instant access, security and redundancy in case of failure of one of the stakeholders. By utilizing an authentication server for verification of individual grants and blocks, the system and method save the need for other verification methods such as proof-of work, thereby improving the operation of the computers and lessening the resources required to implement a block chain. This also allows the system to run in much more resource constrained environments than would normally be possible. Further, because this may be run on smaller systems, the inherent security of the multitude is lost, so the blockchain may be constructed behind a secure network or with secured access. This has an added benefit of lessening the network load needed to update the stakeholders because fewer copies of the distributed journal are necessary to ensure security.

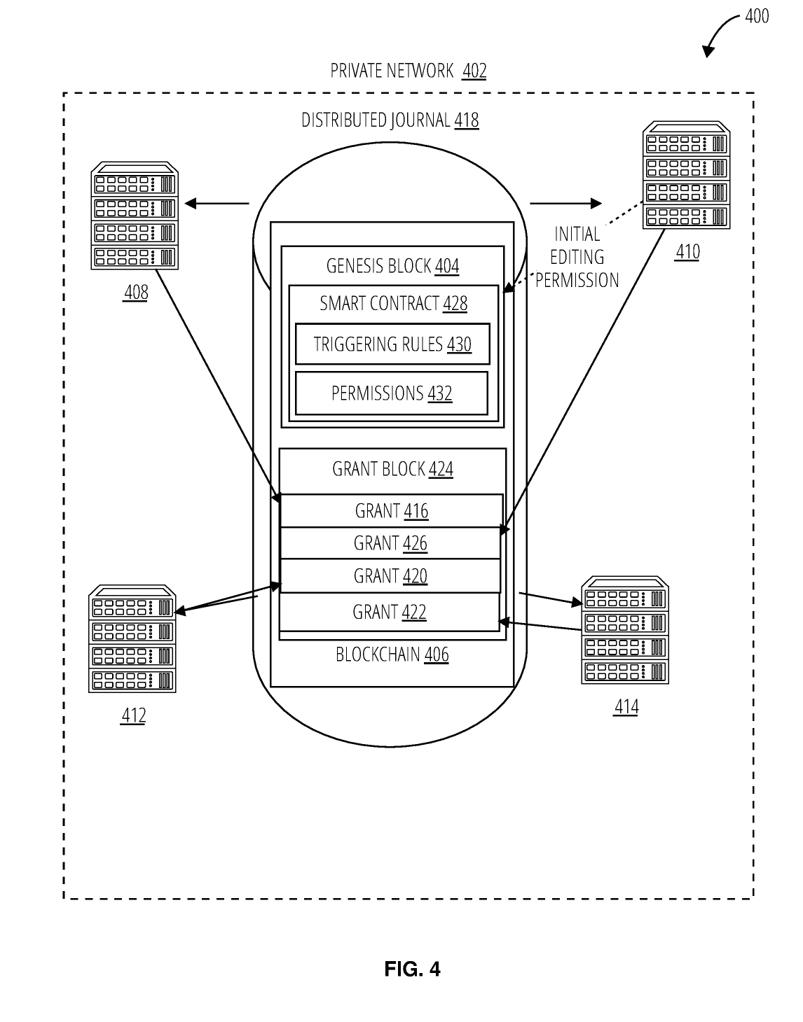

FIG. 4 illustrates an embodiment of a distributed journal system 400.

The distributed journal system 400 comprises permissions 432, a grant block 424, a smart contract 428, a blockchain 406, a stakeholder device 412, a grant 416, a grant 426, a grant 420, a grant 422, a stakeholder device 408, a stakeholder device 410, a stakeholder device 414, a private network 402, a genesis block 404, and a distributed journal 418.

The distributed journal 418 is distributed over stakeholder device 408, stakeholder device 412, stakeholder device 410 and stakeholder device 414. The stakeholder device 408 sends grant 416 to the distributed journal 418, the stakeholder device 412 sends the grant 420 to the distributed journal 418, the stakeholder device 410 sends the grant 426 to the distributed journal 418, the stakeholder device 414 sends the grant 422 to the distributed journal 418. The distributed journal 418 assembles the grant 416, the grant 426, the grant 420 and the 332 into the completed blockchain 406. The distributed journal 418 is updated on the stakeholder device 408, the stakeholder device 412, the stakeholder device 410 and the stakeholder device 414.

Traditional blockchain is redundantly secured through the number of copies of the blockchain which are distributed over the network and also through the verification of blocks. In current methods of employing blockchains, for example Bitcoin, blocks are verified through a decryption process known as mining. Due to the smaller number of stakeholders in the present system, the private network 402 may be used to secure access to the distributed journal 418. The genesis block 404 may further comprise the smart contract 428. The permissions 432 in the smart contract 428 may delineate which people may access the private network 402 and also who may write to the blockchain 406. The private network may use standard means of authenticating access.

The genesis block establishes the contract terms and specifies which systems and users may have access and write permissions to the block chain. If the contract must be modified at a later time, a new block chain must be created from a new genesis block specifying the changes. Including the contract and permissions in the genesis block and making each block immutable after one write, the chain removes the requirement of distributed block authentication and verification through requiring proof of work/proof of stake, or other computationally intensive measures, thereby lessening the overall computer resources necessary to implement the system.

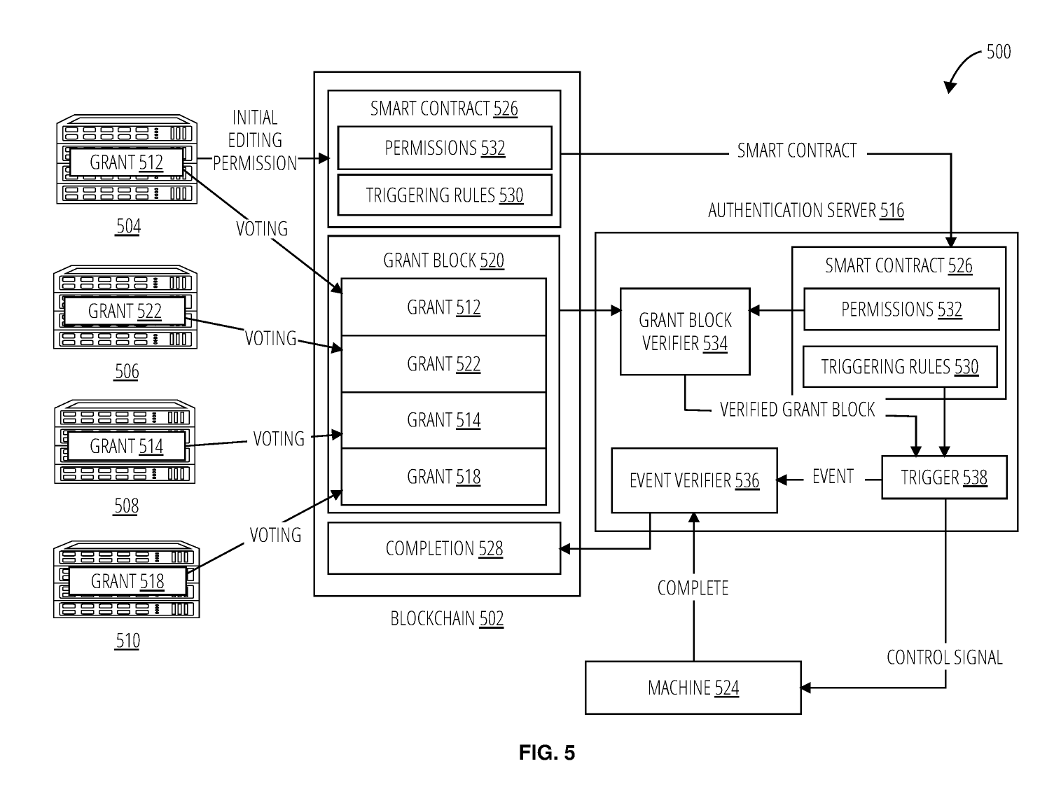

FIG. 5 illustrates an embodiment of a system for distributed permissioning and remote machine operation 500.

The system for distributed permissioning and remote machine operation 500 comprises permissions 532, a grant block 520, a machine 524, a smart contract 526, a blockchain 502, a completion 528, an authentication server 516, triggering rules 530, a grant block verifier 534, a trigger 538, an event verifier 536, a stakeholder device 508, a grant 512, a grant 522, a grant 514, a grant 518, a stakeholder device 504, a stakeholder device 506, and a stakeholder device 510.

The smart contract 526 further comprises the permissions 532 and the triggering rules 530. The permissions 532 may define the permissions for who may access the blockchain 502 and who may write to each block. The triggering rules 530 may define the necessary grants which much be received and written to the grant block 520 in order to trigger an event.

The system for distributed permissioning and remote machine operation 500 allows for the remote operation of a machine 524 through distributed permissioning.

The stakeholder device 508 sends the grant 512 to the blockchain 502, the stakeholder device 506 sends to grant 522 to the blockchain 502, the stakeholder device 508 sends the grant 514 to the blockchain 502, the stakeholder device 510 sends the grant 518 to the blockchain 502. The blockchain 502 assembles the grant 512, the grant 522, the grant 514 and the grant 518 into the grant block 520.

A third party trusted server may be utilized, in a manner similar to a third-party certificate authority in public-private key cryptography. The authentication server 516 receives the grant block 520 and the smart contract 526 from the blockchain 502. The permissions 532 configure the grant block verifier 534 to verify the grants in the grant block 520. The triggering rules 530 configure the trigger 538 to initiate a control signal to machine 524 upon receipt of a verified grant block 520 with the grants specified in the triggering rules 530. The trigger 538 configures the event verifier 536 with the event triggered by the trigger 538 to write a work completion 528 block to the blockchain 502.

The triggering rules 530 may specify which grants are necessary and how much consensus is necessary between stakeholders. The permissions 532 may specify which stakeholders and users may have access to the blockchain 502.

The smart contract 526 may be contained within the genesis block and may specify which stakeholders may create a blockchain and initiate a smart contract and genesis block. This ability may be granted by the initial approved stakeholder to other stakeholders.

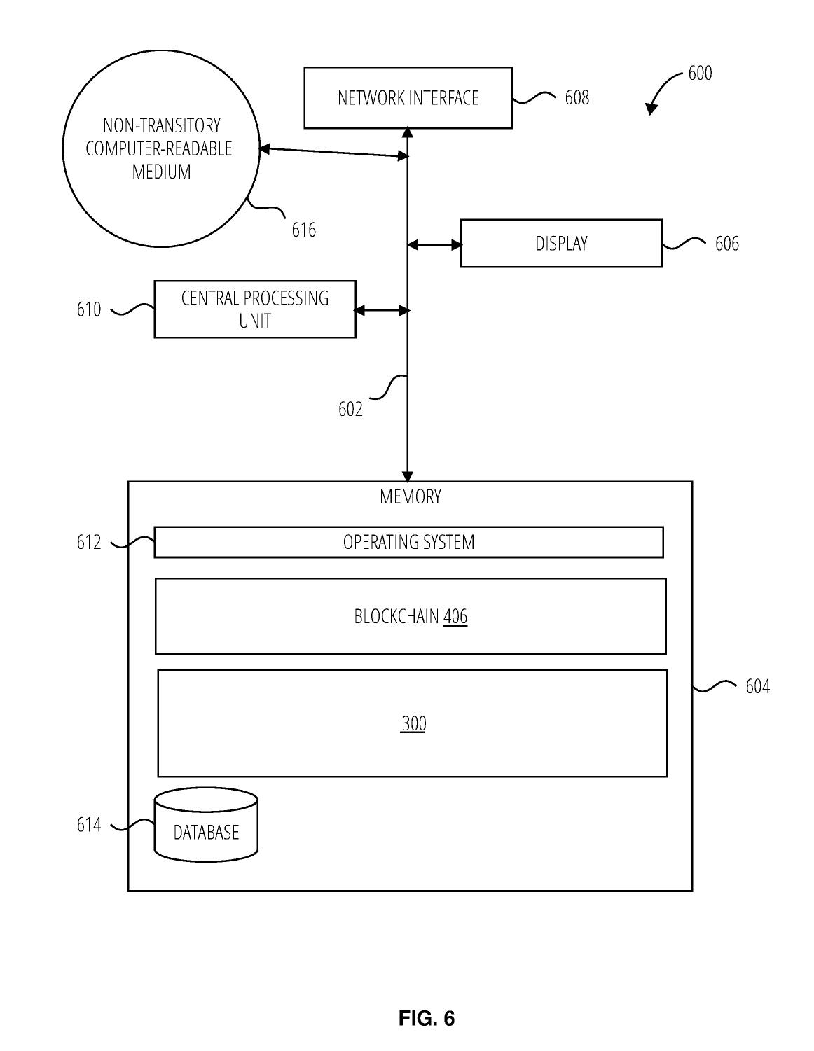

FIG. 6 illustrates several components of an exemplary system 600 in accordance with one embodiment. In various embodiments, system 600 may include a desktop PC, server, workstation, mobile phone, laptop, tablet, set-top box, appliance, or other computing apparatus or device that is capable of performing operations such as those described herein. In some embodiments, system 600 may include many more components than those shown in FIG. 6. However, it is not necessary that all of these generally conventional components be shown in order to disclose an illustrative embodiment. Collectively, the various tangible components or a subset of the tangible components may be referred to herein as “logic” configured or adapted in a particular way, for example as logic configured or adapted with particular software or firmware.

In various embodiments, system 600 may comprise one or more physical and/or logical devices that collectively provide the functionalities described herein. In some embodiments, system 600 may comprise one or more replicated and/or distributed physical or logical devices.

In some embodiments, system 600 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

System 600 includes a bus 602 interconnecting several components including a network interface 608, a display 606, a central processing unit 610, and a memory 604.

Memory 604 generally comprises a random access memory (“RAM”) and permanent non-transitory mass storage device, such as a hard disk drive or solid-state drive. Memory 604 stores an operating system 612.

These and other software components may be loaded into memory 604 of system 600 using a drive mechanism (not shown) associated with a non-transitory computer-readable medium 616, such as a DVD/CD-ROM drive, memory card, network download, or the like.

Memory 604 also includes database 614. In some embodiments, system 600 may communicate with database 614 via network interface 608, a storage area network (“SAN”), a high-speed serial bus, and/or via the other suitable communication technology.

In some embodiments, database 614 may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

Terminology and Interpretation

Terms used herein should be accorded their ordinary meaning in the relevant arts, or the meaning indicated by their use in context, but if an express definition is provided, that meaning controls.

References to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” in this context refers to logic implemented as processor-executable instructions in a machine memory (e.g. read/write volatile or nonvolatile memory or media).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

What is claimed is:

1. A method comprising:
defining a genesis block of a blockchain within a private network comprising a smart contract, the smart contract further comprising permissions and triggering rules;
a plurality of stakeholders transmitting a plurality of grants to a grant block within the blockchain;
an authentication server receiving the grant block and the smart contract from the blockchain;
configuring a grant block verifier in the authentication server with the grant block and the permissions to verify each of the plurality of grants;
configuring a trigger with the triggering rule from the smart contract and a verified grant signal from the grant block verifier to transmit a control signal to operate a machine; and
configuring an event verifier with an event from the trigger to receive a completion signal from the machine and write a completion block to the blockchain.

2. The method of claim 1 wherein the permissions define who may access or create the blockchain and who may write to each block.

3. The method of claim 1 wherein the triggering rules may define the necessary grants which much be recorded and written to the grant block in order to initiate an event.

4. The method of claim 1 wherein the stakeholders transmitting grants to the grant block further comprises saving the grant to the local copy of the grant block while connected to the private network and updating the other copies on the private network.

5. A computing apparatus, the computing apparatus comprising:
a processor; and
a memory storing instructions that, when executed by the processor, configure the apparatus to:
define a genesis block of a blockchain within a private network comprising a smart contract, the smart contract further comprising permissions and triggering rules;
a plurality of stakeholders transmit a plurality of grants to a grant block within the blockchain;
an authentication server receiving the grant block and the smart contract from the blockchain;
configure a grant block verifier in the authentication server with the grant block and the permissions to verify each of the plurality of grants;
configure a trigger with the triggering rule from the smart contract and a verified grant signal from the grant block verifier to transmit a control signal to operate a machine; and
configure an event verifier with an event from the trigger to receive a completion signal from the machine and write a completion block to the blockchain.

6. The computing apparatus of claim 5 wherein the permissions define who may access the blockchain and who may write to each block.

7. The computing apparatus of claim 5 wherein the triggering rules may define the necessary grants which much be recorded and written to the grant block in order to initiate an event.

8. The computing apparatus of claim 5 wherein the stakeholders transmit grants to the grant block further comprises saving the grant to the local copy of the grant block while connected to the private network.
